(19) United States
(12) Patent Application Publication
(10) Pub. No.: US 2026/0065344 A1
(43) Pub. Date: Mar. 5, 2026

(54) CONTEXTUALIZATION AND VALIDATION OF PRODUCT VALUE

(71) Applicant: INTERNATIONAL BUSINESS MACHINES CORPORATION, Armonk, NY (US)

(72) Inventors: Zachary Augustus Silverstein, Georgetown (TX); Logan Bailey, Atlanta, GA (US); Suman Patra, KOLKATA (IN); Fang Lu, Billerica, MA (US)

(21) Appl. No.: 18/820,389

(22) Filed: Aug. 30, 2024

(51) Int. Cl. G06Q 30/0601; G06N 3/0464

(52) U.S. Cl. CPC G06Q 30/0629; G06N 3/0464; G06Q 30/0631

(57) ABSTRACT

Embodiments determine at least one product interest based on user information, receive historical data from a plurality of users, train a convolutional neural network (CNN) model based on the historical data, determine a plurality of user task interactions related to the at least one product interest based on the trained CNN model, monitor the user task interactions for a user product related to the at least one product interest over a predetermined period of time, generate a digital twin of a comparative product to the user product based on the monitored user interactions, generate user performance metrics including a return on investment (ROI) of the generated digital twin, and generate a recommendation to purchase a product of the at least one product interest based on the generated user performance metrics including the ROI being greater than a cost of the product.

### BACKGROUND

Aspects of the present invention relate generally to contextualizing a return on investment (ROI) and added value of a product.

Electronic commerce allows individuals to access thousands of products for purchase. In this situation, individuals determine a value and a cost when determining whether to purchase a product.

### SUMMARY

In a first aspect of the invention, there is a computer-implemented method including: determining, by a processor set, at least one product interest based on user information; receiving, by the processor set, historical data from a plurality of users; training, by the processor set, a convolutional neural network (CNN) model based on the historical data; determining, by the processor set, a plurality of user task interactions related to the at least one product interest based on the trained CNN model; monitoring, by the processor set, the user task interactions for a user product related to the at least one product interest over a predetermined period of time; generating, by the processor set, a digital twin of a comparative product to the user product based on the monitored user interactions; generating, by the processor set, user performance metrics including a return on investment (ROI) of the generated digital twin; and generating, by the processor set, a recommendation to purchase a product of the at least one product interest based on the generated user performance metrics including the RIO being greater than a cost of the product.

In another aspect of the invention, there is a computer program product including one or more computer readable storage media having program instructions collectively stored on the one or more computer readable storage media. The program instructions are executable to: determine at least one product interest based on user information; receive historical data from a plurality of users; train a convolutional neural network (CNN) model based on the historical data; determine a plurality of user task interactions related to the at least one product interest based on the trained CNN model; monitor the user task interactions for a user product related to the at least one product interest over a predetermined period of time; generate a 3D physical product of a comparative product to the user product based on the monitored user interactions; generate user performance metrics including a return on investment (ROI) of the generated 3D physical product; and generate a recommendation to purchase a product of the at least one product interest based on the generated user performance metrics including the ROI being greater than a cost of the product.

In another aspect of the invention, there is a system including a processor set, one or more computer readable storage media, and program instructions collectively stored on the one or more computer readable storage media. The program instructions are executable to: receive an opt-in from at least one user to grant access to user information; determine at least one product interest based on the user information; receive historical data from at least one of a kinematic model, an object recognition model, and an activity recognition model; train a convolutional neural network (CNN) model using a CNN algorithm based on the historical data; determine a plurality of user task interactions related to the at least one product interest based on the trained CNN model; monitor the user task interactions for a user product using at least one of a camera and an internet of things (IoT) device related to the at least one product interest over a predetermined period of time; generate a digital twin using augmented reality (AR) of a comparative product to the user product based on the monitored user interactions; generate user performance metrics including a return on investment (ROI) of the generated digital twin; and generate a recommendation to purchase a product of the at least one product interest based on the generated user performance metrics including the RIO being greater than a cost of the product.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows another block diagram of an exemplary method in accordance with aspects of the present invention.

FIG. 5 shows another flowchart of an exemplary method in accordance with aspects of the present invention.

FIG. 6 shows another flowchart of an exemplary method in accordance with aspects of the present invention.

### DETAILED DESCRIPTION

Aspects of the present invention relate generally to contextualizing a return on investment (ROI) and added value of a product and, more particularly, to providing a commercial contextualization and validation of product value through a mixed reality (MR) simulation and context capturing. Embodiments of the present invention quantify decision-making metrics for purchase decisions. In particular, embodiments of the present invention contextualize a ROI and added value to a product not yet owned.

Embodiments of the present invention provide a system and a method to contextualize an action taken during feed data and provide quantitative value to a user based on an interaction time. Aspects of the present invention calculate an expected execution time and replacement time of a new product based on metrics at a task level. Further embodiments of the present invention quantify a price of a product against usage metrics and saved time based on interaction data. Aspects of the present invention provide commerce feed products which are based on products of interest to a user based on a wish list, a vendor identification, etc. Embodiments of the present invention capture a value of a reduction in a user's time spent and a value in an hourly rate. Aspects of the present invention provide an augmented reality or virtual rendering of a device or a 3D printed dummy version to gauge user interaction time.

Aspects of the present invention include a method, system, and computer program product for determining whether to purchase a product or service based on comparing a ROI associated with a product or service to a cost of the product or the service. For example, a computer-implemented method includes: determining a product or service of interest of a user based on a user's purchase history and search history; monitoring (i) a user's interaction with a 3-D printed version of the product or the service of interest or (ii) a user's interaction with an augmented reality or a virtual reality version of the product or the service of interest to capture relevant interaction metrics, such as ease of use compared to a currently used product or service, user over time, time saved compared to the currently used product or service, changes in productivity or quality compared to the currently used product or service; calculating the ROI for the product or service of interest based on the captured relevant interaction metrics; and generating a recommendation to purchase the product or service of interest in response to the calculated ROI being greater than a cost of the product or service of interest. Further, the computer-implemented method may also include the monitoring the user's instructions further including rendering the user's interactions via a human interaction model, such as a kinematic model, and validating the user's interactions rendered vias the human interaction model using a convolutional neural network (CNN).

Embodiments of the present invention provide a system, a method, and a computer program product to utilize feed data to contextualize an ROI and provide additional quantitative value of a product that is not yet owned by an individual. In comparison, conventional systems are not able to quantify and contextualize decision making metrics that includes a quantitative value corresponding to a user interaction with a product or service. Therefore, conventional systems limit the ability of the user to make an accurate purchase decision. Embodiments of the present invention assign a value to a product not yet owned for a user purchase decision. Aspects of the present invention also contextualize an action taken by a user to provide a quantitative value to a user based on an interaction time of the user.

Embodiments of the present invention include a system, method, and computer program product for quantifying a price of a product against user metrics and a time saved based on interaction data. Accordingly, implementations of the present invention provide an improvement (i.e., technical solution) to a problem arising in the technical field of providing decision metrics for purchasing products. In particular, embodiments of the present invention provide at least one product based on products of interest to a user based on a wish list and a vendor identification. Embodiments of the present invention also capture a value related to a reduction in a user's time spent represented by an hourly rate. Embodiments of the present invention also use an artificial rendering or virtual rendering of a device or a 3D printed version to gauge interaction time.

Implementations of the present invention are necessarily rooted in computer technology. For example, the step of training a convolutional neural network (CNN) model based on the historical data is computer-based and cannot be performed in the human mind. Training and building the CNN model is, by definition, performed by a computer and cannot practically be performed in the human mind (or with pen and paper) due to the complexity and massive amounts of calculations involved. For example, training and building the CNN model in embodiments of the present invention may use a CNN algorithm to build and train the CNN model for image recognition and image classification based on the historical data to improve accuracy of the CNN model for monitoring user interactions. In particular, training and building the CNN model involves a large among of processing of historical data to train the CNN model such that the CNN model generates and outputs in real time (or near real time). In other words, the CNN model is trained using a large amount of previously captured historical data such that the CNN model is configured to output user task interactions. Given the scale and complexity of processing historical data and modeling of parameters, it is simply not possible for the human mind, or for a person using pen and paper, to perform the number of calculations involved in training and/or building the CNN model.

It should be understood that, to the extent implementations of the invention collect, store, or employ personal information provided by, or obtained from, individuals (for example, a user that is interested in purchasing a product, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as contextualization and validation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

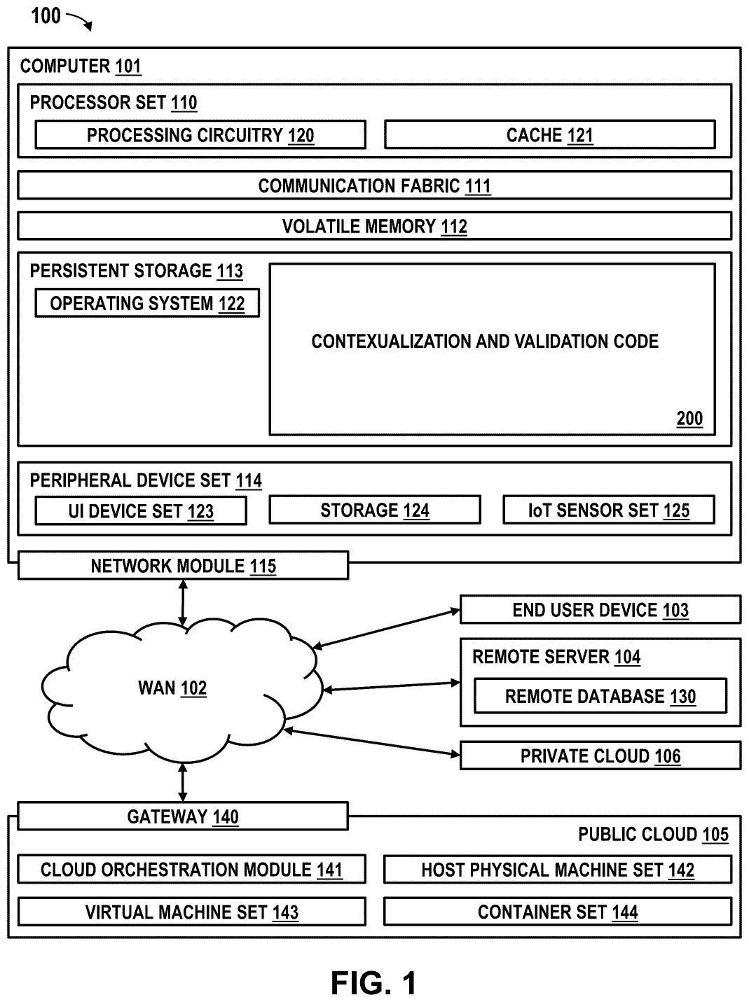

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

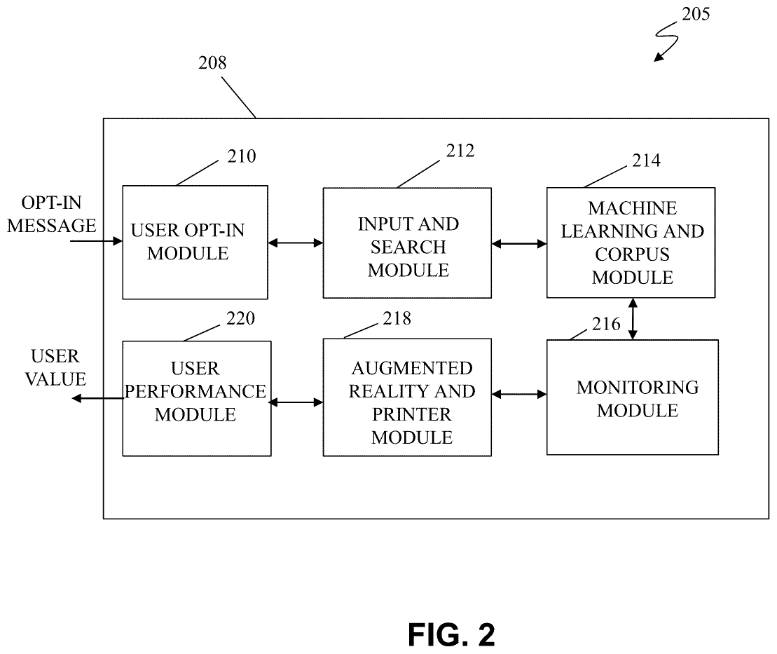

FIG. 2 shows a block diagram of an exemplary environment 205 in accordance with aspects of the invention. In embodiments, the environment 205 includes a contextualization and validation server 208, which may comprise one or more instances of the computer 101 of FIG. 1. In other examples, the contextualization and validation server 208 comprises one or more virtual machines or one or more containers running on one or more instances of the computer 101 of FIG. 1.

In embodiments, the contextualization and validation server 208 of FIG. 2 comprises a user opt-in module 210, an input and search module 212, a machine learning module and corpus module 214, a monitoring module 216, an augmented reality and printer module 218, and a user performance module 220, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The contextualization and validation server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the present invention, the user opt-in module 210 receives an opt-in message from an external device and allows a user to opt-in to grant access to information of the user. For example, the external device comprises an external mobile user device such as a laptop computer, tablet computer, or smartphone, for example and without limitation. In further embodiments, the user opt-in module 210 allows the user to opt-in to grant access to an internet of things (IoT) component, an augmented reality (AR) component, and the external device for obtaining information of the user. In aspects of the present invention, the user opt-in module 210 sends the opt-in message to the input and search module 212 so that the input and search module 212 is able to communicate with the external device.

In embodiments of FIG. 2, the input and search module 212 communicates with the external device to receive an input from at least one of a wish list, view information, or a social media account which describes products that are highly relevant to the user and search for the products that are highly relevant to the user. In embodiments, the input and search module 212 has access to an internet of things (IoT) component, an augmented reality (AR) component, and the external device for obtaining information of the user. In further embodiments, the input and search module 212 communicates with the external device to receive input regarding an order history and account management of the user related to previous purchases from the user. In further aspects of the present invention, the input and search module 212 communicates with the external device to receive products that are highly relevant to the user based on vendor-side information. As an example, the input and search module 212 may receive information from the social media account of the user which indicates that the user is looking to purchase a keyboard. The input and search module 212 sends the information regarding the products that are highly relevant to the user to the machine learning and corpus module 214.

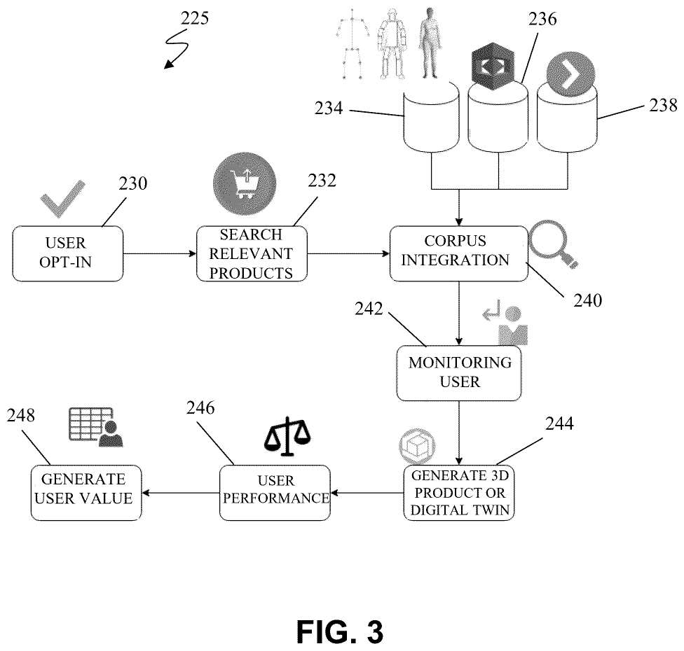

In embodiments, the machine learning and corpus module 214 receives the information regarding the products that are highly relevant to the user and then extracts model information from a plurality of models based on the information regarding the products that are highly relevant to the user. In particular, the machine learning and corpus module 214 extracts model information from the plurality of models including a kinematic model 234, an object recognition model 236, and an activity recognition model 238 (as shown in FIG. 3). In further embodiments, the machine learning and corpus module 214 extracts expected user interaction information from the kinematic model 234 corresponding to the information regarding the products that are highly relevant to the user, extracts object recognition information from the object recognition module 236 corresponding to the information regarding the products that are highly relevant to the user, and extracts activating information from the activity recognition model 238 corresponding to the information regarding the products that are highly relevant to the user. In aspects of the present invention, the machine learning and corpus module 214 saves and integrates the expected user interaction information, the object recognition information, and the activating information in a corpus. In further embodiments, the corpus comprises a collection of information that is stored in the machine learning and corpus module 214. For example, the kinematic model 234 includes historical user interactions regarding how users interact with a keyboard, the object recognition model 236 includes historical objects that are recognized on the keyboard, and the activity recognition model 238 includes historical actions that the user takes that are related to the keyboard, and saves and integrates the historical user interactions, the historical objects, and the historical actions in the corpus. The machine learning and corpus module 214 trains a convolutional neural network (CNN) model using a convolutional neural network (CNN) algorithm for image recognition and image classification based on the corpus. The machine learning and corpus module 214 continuously trains using new historical data to improve the accuracy of the CNN model for extracting the model information from the plurality of models. In embodiments, the machine learning and corpus module 214 resides in a cloud infrastructure or a local agent and verifies the corpus against the user information received from the external device. The machine learning and corpus module 214 sends information from the corpus and the trained CNN model to the monitoring module 216.

In further embodiments of FIG. 2, the monitoring module 216 determines and monitors user interactions with at least one product that the user uses based on the corpus and the trained CNN model. For example, the monitoring module 216 monitors user interactions with a current keyboard that the user uses. In aspects of the present invention, the monitoring module 216 monitors the user interactions with the current keyboard using at least one of a camera and an IoT device that captures the user interactions. In further embodiments, the monitoring module 216 monitors the user interactions with the at least one product over a predetermined period of time. In other embodiments, the monitoring module 216 monitors the user interactions with the at least one product over the predetermined period of time by capturing the daily user interactions. In further embodiments, the monitoring module 216 monitors the user interactions with the at least one product over the predetermined period of time. In aspects of the present invention, the monitoring module 216 monitors the user interactions by capturing a time of execution, a number of user repetitive tasks, user frustration metrics, etc. For example, the monitoring module 216 captures a plurality of metrics for the at least one product that the user uses such as a cost per use (e.g., $0.003 per use), a cost per day ($0.24 per day), a beneficial value (e.g., productivity gain) against product cost for breakeven calculations, and an hourly rate of an individual ($20 per hour). The monitoring module 216 also monitors the user interactions by further capturing actual environmental factors, such as temperature, humidity, etc. In this scenario, the monitoring module 216 increases the accuracy of a time the user utilizes the product by further capturing actual environmental factors. In an example, the monitoring tracking module 216 captures changes in temperature and humidity and maps the captured changes in temperature and humidity with the time the user utilizes the product through a historical environmental database. The monitoring module 216 then sends the plurality of metrics to the augmented reality and printer module 218.

In aspects of the present invention, the augmented reality and printer module 218 receives the plurality of metrics from the monitoring module 218 and creates a digital twin of one of the products that are highly relevant to the user. In embodiments, the augmented reality and printer module 218 creates an augmented reality (AR) digital twin using an AR component based on the plurality of metrics from the monitoring module 216. In further embodiments, the augmented reality and printer module 218 creates a 3D physical product using a 3D printer device. In aspects of the present invention, the augmented reality and printer module 218 creates the 3D physical product using the 3D printer device based on usage by the user. For example, the augmented reality and printer module 218 creates the 3D physical product using a first version of the product in response to the user having a usage greater than or equal to a usage threshold of the product. In another example, the augmented reality and printer module 218 creates the 3D physical product using a second version of the product in response to the user having a usage less than the usage threshold. In embodiments, the first version of the product has a higher quality than a quality the second version of the product. Accordingly, the augmented reality and printer module 218 improves a satisfaction of a user experience by creating a 3D physical product which has an overall quality corresponding to the usage of the user.

In embodiments of FIG. 2, the user performance module 220 then gauges user performance of either the 3D physical product or the AR digital twin. For example, the user performance module 220 captures the plurality of metrics such as the cost per use (e.g., $0.003 per use), the cost per day ($0.24 per day), a return on investment (ROI) which comprises the beneficial value (e.g., the productivity gain) against the product cost, and the hourly rate of the individual ($20 per hour). The user performance module 220 captures the plurality of metrics of the 3D physical product or the AR digital twin using at least one of the camera and the IoT device.

In further embodiments of FIG. 2, the user performance module 220 provides a user value based on the captured plurality of metrics of the 3D physical product or the AR digital twin. In aspects of the present invention, the user performance module 220 provides the user value which corresponds with an expected execution time and replacement time of a new product and an injection of the new product into a task. For example, the new product has functional characteristics which are the same as the captured plurality of metrics of one of the 3D physical product or the AR digital twin in response to the user performance module 220 determining that the captured plurality of metrics of one of the 3D physical product or the AR digital twin are within acceptable threshold metrics. In another example, the new product has functional characteristics which are different from the one of the 3D physical product or the AR digital twin in response to the user performance module 220 determining that the captured plurality of metrics of one of the 3D physical product or the AR digital twin are being outside the acceptable threshold metrics. In aspects of the present invention, the user performance module 220 purchases one product of the at least one product interest based on the user value being within acceptable threshold metrics. Further, although aspects of the present invention have been described with respect to purchasing at least one product, embodiments of the present invention are not limited to this example and can also be directed to purchasing at least one service.

FIG. 3 shows a flowchart of an exemplary method in accordance with aspects of the present invention. Steps of the method may be carried out in the environment of FIG. 2 and are described with reference to elements depicted in FIG. 2.

In the flowchart 225, at step 230, the system receives, by the user opt-in module 210, an opt-in message from an external device and allows a user to opt-in to grant access to information of the user. At step 232, the system communicates, by the input and search module 212, with the external device to receive an input from at least one of a wish list, view information, or a social media account which describes products that are highly relevant to the user and search for the products that are highly relevant to the user. At step 240, the system receives, by the machine learning and corpus module 214, the information regarding the products that are highly relevant to the user and then extracts model information from a plurality of models based on the information regarding the products that are highly relevant to the user. In particular, the machine learning and corpus module 214 extracts expected historical user interaction information from the kinematic model 234 corresponding to the historical information regarding the products that are highly relevant to the user, extracts historical object recognition information from an object recognition module 236 corresponding to the historical information regarding the products that are highly relevant to the user, and extracts historical activating information from an activity recognition model 238 corresponding to the historical information regarding the products that are highly relevant to the user. In aspects of the present invention, the machine learning and corpus module 214 saves and integrates the expected historical user interaction information, the historical object recognition information, and the historical activating information in a corpus.

At step 242, the system monitors, by the monitoring module 216, user interactions with at least one product that the user uses. In aspects of the present invention, the monitoring module 216 monitors the user interactions of the at least one product that the user uses by utilizing at least one of a camera and an IoT device that captures the user interactions. At step 244, the system creates, by the augmented reality and printer module 218, one of a digital twin by AR using the monitored user interactions and a 3D product by a 3D printer device using the monitored user interactions.

At step 246, the system gauges, by the user performance module 220, user performance of one of the 3D physical product and the digital twin. In embodiments, the user performance module 220 captures the plurality of metrics such as the cost per use (e.g., $0.003 per use), the cost per day ($0.24 per day), the beneficial value (e.g., the productivity gain) against the product cost, and the hourly rate of the individual ($20 per hour). At system 248, the system generates, by the user performance module 220, a user value based on the captured plurality of metrics of one of the 3D physical product and the digital twin.

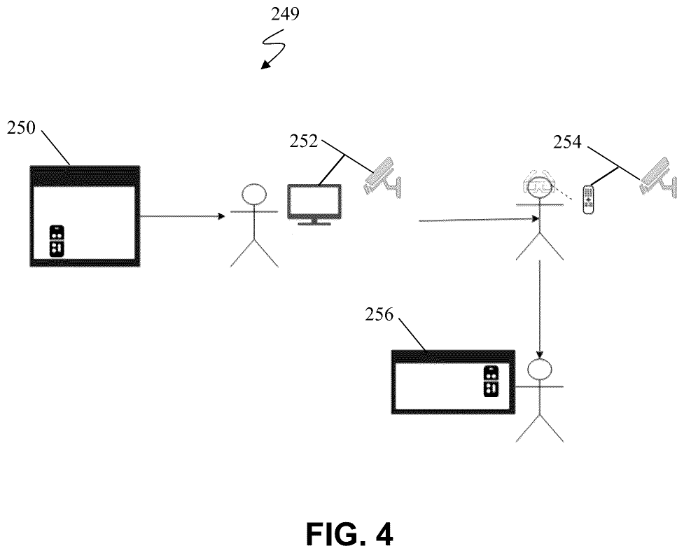

FIG. 4 shows another flowchart of an exemplary method in accordance with aspects of the present invention. Steps of the method may be carried out in the environment of FIG. 2 and are described with reference to elements depicted in FIG. 2.

In the flowchart 249, at step 250, the system receives, by the user opt-in module 210, an opt-in message from an external device and allows a user to opt-in to grant access to information of the user. In further embodiments, the system communicates, by the input and search module 212, with the external device to receive an input from at least one of a wish list, view information, or a social media account which describes products that are highly relevant to the user and search for the products that are highly relevant to the user. In aspects of the present invention, the system receives, by the machine learning and corpus module 214, the at least one television remote that is highly relevant to the user and then extracts model information from a plurality of models based on historical information regarding the television remote products that are highly relevant to the user. In particular, the machine learning and corpus module 214 extracts expected historical user interaction information from the kinematic model 234 corresponding to the information regarding the at least one television remote that is highly relevant to the user, extracts historical object recognition information from an object recognition module 236 corresponding to the information regarding the at least one television remote that is highly relevant to the user, and extracts historical activating information from an activity recognition model 238 corresponding to the information regarding the at least one television remote that is highly relevant to the user. In aspects of the present invention, the machine learning and corpus module 214 saves and integrates the expected historical user interaction information, the historical object recognition information, and the historical activating information in a corpus.

At step 252, the system monitors, by the monitoring module 216, user interactions with at least one current television remote that the user uses. In aspects of the present invention, the monitoring module 216 monitors the user interactions with the at least one current television remote that the user uses by utilizing at least one of a camera and an IoT device that captures the user interactions. At step 254, the system creates, by the augmented reality and printer module 218, an AR digital twin of the at least one television remote that is highly relevant to the user.

At step 256, the system gauges, by the user performance module 220, user performance of the AR digital twin of the at least one television remote that is highly relevant to the user. In embodiments, the user performance module 220 captures a plurality of metrics such as the cost per use (e.g., $0.003 per use), the cost per day ($0.24 per day), the beneficial value (e.g., the productivity gain) against the product cost, and the hourly rate of the individual ($20 per hour). In further embodiments, the system generates, by the user performance module 220, a user value based on the captured plurality of metrics of the AR digital twin.

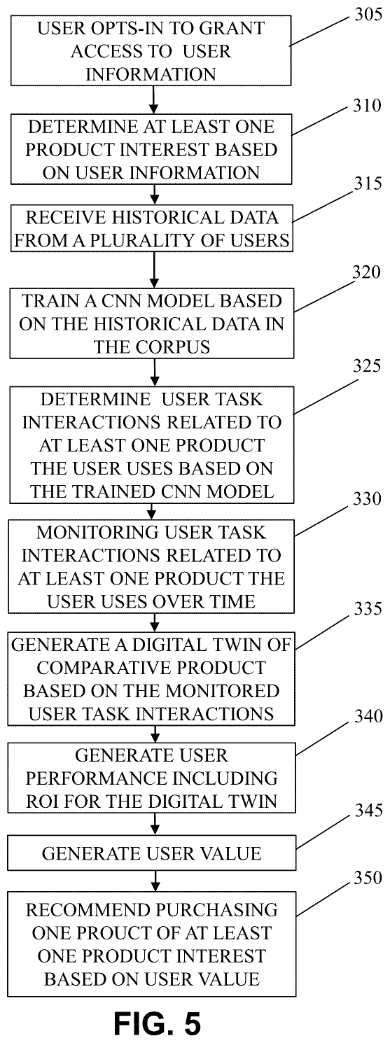

FIG. 5 shows a flowchart of an exemplary method in accordance with aspects of the present invention. Steps of the method may be carried out in the environment of FIG. 2 and are described with reference to elements depicted in FIG. 2.

At step 305, the system allows, by the user opt-in module 210, a user to opt-in to grant access to information of the user. At step 310, the system determines, by the input and search module 212, at least one product interest based on user information from at least one of a wish list, view information, and a social media account. At step 315, the system receives, at the machine learning and corpus module 214, historical data of a plurality of users from a kinematic model 234, an object recognition model 236, and an activity recognition model 238. In embodiments and as described with respect to FIG. 2, the historical data includes historical user interactions regarding how users interact with at least one product which is highly relevant to the user, historical objects regarding how users interact with at least one product which is highly relevant to the user, and historical actions regarding how users interact with at least one product which is highly relevant to the user, and saves and integrates the historical user interactions, the historical objects, and the historical actions in a corpus. At step 320, the system trains, at the machine learning and corpus module 214, a convolutional neural network (CNN) model using a convolutional neural network (CNN) algorithm for image recognition and image classification based on the historical data in the corpus. In embodiments and as described with respect to FIG. 2, the machine learning and corpus module 214 continuously trains the CNN model using new historical data to improve the accuracy of the CNN model for extracting the model information from the plurality of models including the kinematic model 234, the object recognition model 236, and the activity recognition model 238.

At step 325, the system determines, at the monitoring module 216, user task interactions related to at least one product that the user uses based on the trained CNN model. At step 330, the system monitors, at the monitoring module 216, the user task interactions related to at least one product that the user uses over a predetermined period of time. At step 335, the system generates, at the augmented reality and printer module 218, a digital twin of a comparative product based on the monitored user task interactions.

At step 340, the system generates, at the user performance module 220, user performance of the digital twin of the comparative product based on the monitored user task interactions. In embodiments and as described with respect to FIG. 2, the user performance module 220 captures the plurality of metrics such as the cost per use (e.g., $0.003 per use), the cost per day ($0.24 per day), a return on investment (ROI) which comprises the beneficial value (e.g., the productivity gain) against the product cost, and the hourly rate of the individual ($20 per hour). At step 345, the system generates, at the user performance module 220, a user value based on the captured plurality of metrics of the digital twin. At step 350, the system recommends, at the user performance module 220, to purchase one product of the at least one product interest based on the user value including the ROI being greater than a cost of the one product.

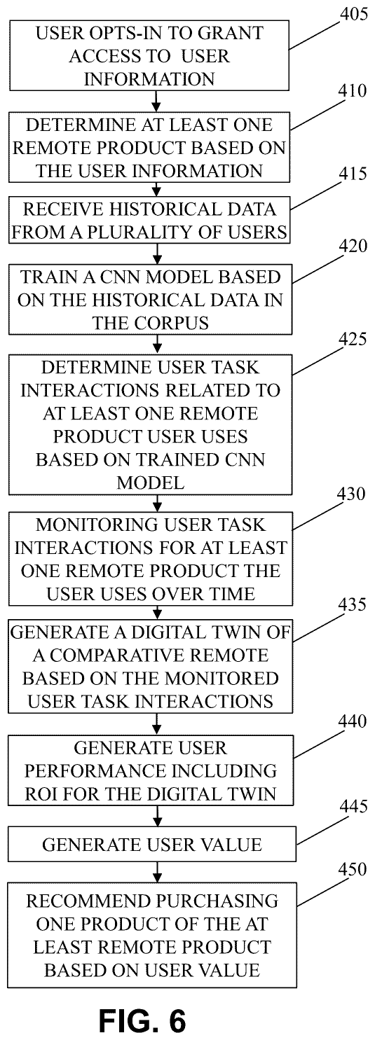

FIG. 6 shows a flowchart of an exemplary method in accordance with aspects of the present invention. Steps of the method may be carried out in the environment of FIG. 2 and are described with reference to elements depicted in FIG. 2.

At step 405, the system allows, by the user opt-in module 210, a user to opt-in to grant access to information of the user. At step 410, the system determines, by the input and search module 212, at least one remote product based on user information from at least one of a wish list, view information, and a social media account. At step 415, the system receives, at the machine learning and corpus module 214, historical data of a plurality of users from a kinematic model 234, an object recognition model 236, and an activity recognition model 238. In embodiments and as described with respect to FIG. 2, the historical data includes historical user interactions regarding how users interact with at least one remote product which is highly relevant to the user, historical objects regarding how users interact with at least one remote product which is highly relevant to the user, and historical actions regarding how users interact with at least one remote product which is highly relevant to the user, and saves and integrates the historical user interactions, the historical objects, and the historical actions in a corpus. At step 420, the system trains, at the machine learning and corpus module 214, a convolutional neural network (CNN) model using a convolutional neural network (CNN) algorithm for image recognition and image classification based on the historical data in the corpus. In embodiments and as described with respect to FIG. 2, the CNN model continuously trains the CNN model using new historical data to improve the accuracy of the CNN model for extracting the model information from the plurality of models including the kinematic model 234, the object recognition model 236, and the activity recognition model 238.

At step 425, the system determines, at the monitoring module 216, user task interactions related to at least one remote product that the user uses based on the trained CNN model. At step 430, the system monitors, at the monitoring module 216, the user task interactions for the at least one remote product that the user uses over a predetermined period of time. At step 435, the system generates, at the augmented reality and printer module 218, a digital twin of a comparative product based on the monitored user task interactions.

At step 440, the system generates, at the user performance module 220, user performance of the digital twin of the comparative product based on the monitored user task interactions. In embodiments and as described with respect to FIG. 2, the user performance module 220 captures the plurality of metrics such as the cost per use (e.g., $0.003 per use), the cost per day ($0.24 per day), a return on investment (ROI) which comprises the beneficial value (e.g., the productivity gain) against the product cost, and the hourly rate of the individual ($20 per hour). At step 445, the system generates, at the user performance module 220, a user value based on the captured plurality of metrics of the digital twin. At step 450, the system recommends, at the user performance module 220, to purchase one product of the at least one remote product interest based on the user value including the ROI being greater than a cost of the one product.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a processor set, at least one product interest based on user information;
receiving, by the processor set, historical data from a plurality of users;
training, by the processor set, a convolutional neural network (CNN) model based on the historical data;
determining, by the processor set, a plurality of user task interactions related to the at least one product interest based on the trained CNN model;
monitoring, by the processor set, the user task interactions for a user product related to the at least one product interest over a predetermined period of time;
generating, by the processor set, a digital twin of a comparative product to the user product based on the monitored user interactions;
generating, by the processor set, user performance metrics including a return on investment (ROI) of the generated digital twin; and
generating, by the processor set, a recommendation to purchase a product of the at least one product interest based on the generated user performance metrics including the ROI being greater than a cost of the product.

2. The computer-implemented method of claim 1, further comprising receiving an opt-in from at least one user to grant access to the user information.

3. The computer-implemented method of claim 2, wherein the user information comprises at least one of a wish list, view information, and a social media account.

4. The computer-implemented method of claim 1, wherein the historical data from the plurality of users is received from at least one of a kinematic model, an object recognition model, and an activity recognition model.

5. The computer-implemented method of claim 4, wherein the kinematic model comprises user interaction information regarding products that are relevant to the user.

6. The computer-implemented method of claim 4, wherein the object recognition model comprises object recognition information regarding products that are relevant to the user.

7. The computer-implemented method of claim 4, wherein the activity recognition model comprises activity recognition information regarding products that are relevant to the user.

8. The computer-implemented method of claim 1, wherein the CNN model is trained using a CNN algorithm for image recognition and image classification based on the historical data.

9. The computer-implemented method of claim 1, wherein the user task interactions are monitored using at least one of a camera and an internet of things (IoT) device.

10. The computer-implemented method of claim 1, wherein the digital twin is generated using augmented reality (AR).

11. The computer-implemented method of claim 1, further comprising purchasing the product based on the generated user performance metrics including the ROI being greater than a cost of the product.

12. A computer program product comprising one or more computer readable storage media having program instructions collectively stored on the one or more computer readable storage media, the program instructions executable to:
determine at least one product interest based on user information;
receive historical data from a plurality of users;
train a convolutional neural network (CNN) model based on the historical data;
determine a plurality of user task interactions related to the at least one product interest based on the trained CNN model;
monitor the user task interactions for a user product related to the at least one product interest over a predetermined period of time;
generate a 3D physical product of a comparative product to the user product based on the monitored user interactions;
generate user performance metrics including a return on investment (ROI) of the generated 3D physical product; and
generate a recommendation to purchase a product of the at least one product interest based on the generated user performance metrics including the ROI being greater than a cost of the product.

13. The computer program product of claim 12, wherein the program instructions are further executable to receive an opt-in from at least one user to grant access to the user information.

14. The computer program product of claim 13, wherein the user information comprises at least one of a wish list, view information, and a social media account.

15. The computer program product of claim 12, wherein the historical data from the plurality of users is received from at least one of a kinematic model, an object recognition model, and an activity recognition model.

16. The computer program product of claim 12, wherein the CNN model is trained using a CNN algorithm for image recognition and image classification based on the historical data.

17. The computer program product of claim 12, wherein the user task interactions are monitored using at least one of a camera and an internet of things (IoT) device.

18. The computer program product of claim 12, wherein the 3D physical product is generated using a 3D printer.

19. The computer program product of claim 12, wherein the program instructions are further executable to purchase the product based on the generated user performance metrics including the ROI being greater than a cost of the product.

20. A system comprising:
a processor set, one or more computer readable storage media, and program instructions collectively stored on the one or more computer readable storage media, the program instructions executable to:
receive an opt-in from at least one user to grant access to user information;
determine at least one product interest based on the user information;
receive historical data from at least one of a kinematic model, an object recognition model, and an activity recognition model;
train a convolutional neural network (CNN) model using a CNN algorithm based on the historical data;
determine a plurality of user task interactions related to the at least one product interest based on the trained CNN model;
monitored the user task interactions for a user product using at least one of a camera and an internet of things (IoT) device related to the at least one product interest over a predetermined period of time;
generate a digital twin using augmented reality (AR) of a comparative product to the user product based on the monitored user interactions;
generate user performance metrics of the generated digital twin; and
generate a recommendation to purchase a product of the at least one product interest based on the generated user performance metrics including the ROI being greater than a cost of the product.
